(19) United States
(12) Patent Application Publication
(10) Pub. No.: US 2020/0364153 A1
(43) Pub. Date: Nov. 19, 2020

(54) RELAY DEVICE, COMPUTER PROGRAM PRODUCT, AND INFORMATION PROCESSING SYSTEM

(71) Applicant: FUJITSU CLIENT COMPUTING LIMITED, Kanagawa (JP)

(72) Inventors: Yuji Nakayama, Kawasaki (JP); Masatoshi Kimura, Kawasaki (JP); Tomohiro Ishida, Kawasaki (JP)

(73) Assignee: FUJITSU CLIENT COMPUTING LIMITED, Kanagawa (JP)

(21) Appl. No.: 16/837,361

(22) Filed: Apr. 1, 2020

(30) Foreign Application Priority Data
May 15, 2019 (JP) 2019-092099

(51) Int. Cl. G06F 12/1072; G06F 12/14; G06F 13/16; G06F 13/20; G06F 13/42

(52) U.S. Cl. CPC G06F 12/1072; G06F 12/1416; G06F 13/4204; G06F 13/20; G06F 13/1663

(57) ABSTRACT

A relay device includes end points to relay communication among information processing devices having root complexes connected to the end points. The relay device includes a hardware processor and circuitry. The hardware processor requests one of the devices to set an address space used to access a setting area for the one of the devices. The setting areas are areas in which access information for accessing public areas on memory spaces of the devices are set. The circuitry translates an address input from the one of the devices, based on a translation rule in which an address of the requested address space has been correlated with an address of the setting area for the one of the devices. The translation rule is stored in an area in which the devices are prohibited from performing rewriting.

### CROSS-REFERENCE TO RELATED APPLICATIONS

This application is based upon and claims the benefit of priority from Japanese Patent Application No. 2019-092099, filed May 15, 2019, the entire contents of which are incorporated herein by reference.

### BACKGROUND

### Technical Field

Embodiments described herein relate to a relay device, a computer program product, and an information processing system.

### Description of the Related Art

In the related art, there has been known a technique of performing parallel computation by using a plurality of information processing devices. For example, there have been proposed information processing systems configured to exchange data between information processing devices by using the Ethernet (registered trademark).

In such information processing systems, each information processing device sets a memory space to be made public among memory spaces of the corresponding information processing device.

However, when each information processing device is able to arbitrarily change a memory space publicized by another information processing device, a non-public area is possibly made public.

Therefore, there is a need for preventing a non-public area from being made public.

### SUMMARY

A relay device according to a first aspect of the present disclosure is provided with a plurality of end points to relay communication over a bus system among a plurality of information processing devices having root complexes connected to the end points. The relay device includes a hardware processor and circuitry. The hardware processor is configured to request one of the information processing devices to set an address space used to access a setting area for the one of the information processing devices among setting areas each being provided in the relay device for each information processing device, the setting areas being areas in which access information for accessing public areas on memory spaces of the information processing devices are set. The circuitry is configured to translate an address being input from the one of the information processing devices, based on a translation rule in which an address of the address space requested by the hardware processor has been correlated with an address of the setting area for the one of the information processing devices, the translation rule being stored in an area in which the information processing devices are prohibited from performing rewriting.

A computer program product according to a second aspect of the present disclosure includes a non-transitory computer-readable recording medium on which an executable program is recorded. The program is executed by a computer as a relay device provided with a plurality of end points to relay communication over a bus system among a plurality of information processing devices having root complexes connected to the end points. The program instructs the computer to: request one of the information processing devices to set an address space used to access a setting area for the one of the information processing devices among setting areas each being provided in the relay device for each information processing device, the setting areas being areas in which access information for accessing public areas on memory spaces of the information processing devices are set; and set a translation rule in which an address of the requested address space has been correlated with an address of the setting area for the one of the information processing devices.

An information processing system according to a third aspect of the present disclosure includes: a plurality of information processing devices each having a root complex; and a relay device provided with a plurality of end points to relay communication over a bus system among the information processing devices each connected to the end point via the root complex. Each of the information processing devices is configured to set access information for accessing a public area on a memory space of the corresponding information processing device. The relay device includes a hardware processor and circuitry. The hardware processor is configured to request one of the information processing devices to set an address space used to access a setting area for the one of the information processing devices among setting areas each being provided in the relay device for each information processing device, the setting areas being areas in which access information for accessing public areas on memory spaces of the information processing devices are set. The circuitry is configured to translate an address being input from the one of the information processing devices, based on a translation rule in which an address of the address space requested by the hardware processor has been correlated with an address of the setting area for the one of the information processing devices, the translation rule being stored in an area in which the information processing devices are prohibited from performing rewriting.

### BRIEF DESCRIPTION OF THE DRAWINGS

FIG. 1 is a diagram illustrating an example of an overall configuration of a distributed computer according to a first embodiment;

FIG. 2 is a diagram for explaining a hardware configuration of the distributed computer according to the first embodiment;

FIG. 3 is a diagram for explaining an example of address translation performed in communication from a platform A to a platform C;

FIG. 4 is a sequence diagram illustrating an example of setting processing according to the first embodiment; and

FIG. 5 is a diagram for explaining a hardware configuration of a distributed computer according to a second embodiment.

### DETAILED DESCRIPTION

Each of the aspects of the present disclosure has an effect of preventing a non-public area from being made public.

Hereinafter, embodiments of a relay device, a computer program product, and an information processing system according to the present disclosure will be described in detail with reference to the drawings. Note that the disclosure is not limited by the embodiments below.

### First Embodiment

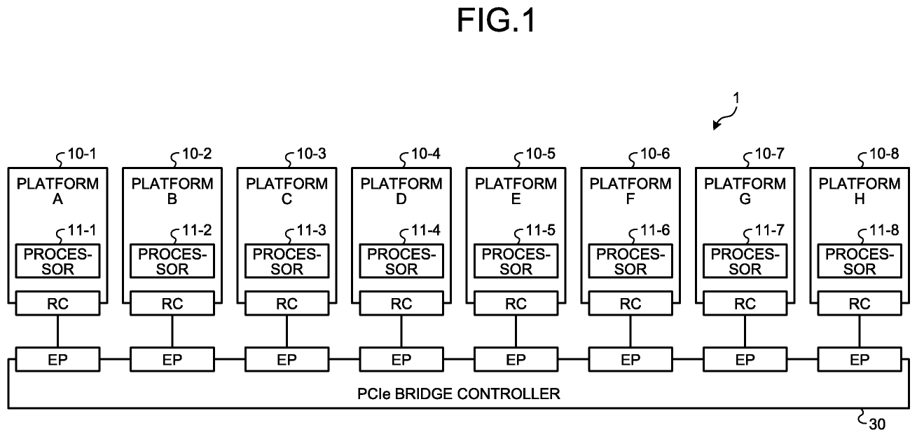

FIG. 1 is a diagram illustrating an example of an overall configuration of a distributed computer 1 according to a first embodiment. The distributed computer 1 is an information processing system including a plurality of platforms A 10-1 to H 10-8 and a PCIe bridge controller 30. The PCIe bridge controller 30 is provided with a plurality of end points to relay communication over a bus system among the platform A 10-1 to the platform H 10-8 having root complex connected to the end points. As illustrated in FIG. 1, the distributed computer 1 according to the embodiment includes the platform A 10-1 to the platform H 10-8 and the PCIe bridge controller 30.

The platform A 10-1 to the platform H 10-8 are communicably connected to one another via the PCIe bridge controller 30. The platform A 10-1 to the platform H 10-8 may be inserted into, for example, slots on a board provided with the PCIe bridge controller 30. Note that any of the slots may be in an empty state in which no node is inserted. In the following description, when it is not necessary to distinguish the platform A 10-1 to the platform H 10-8 from one another and an optional platform is intended, it is described as a platform 10.

The platform A 10-1 is a main information processing device that manages the platform B 10-2 to the platform H 10-8 and allows the platform B 10-2 to the platform H 10-8 to perform various processes.

The platform B 10-2 to the platform H 10-8 are sub information processing devices that perform, for example, artificial intelligence (AI) inference processing, image processing and the like, based on a request of the platform A 10-1.

Furthermore, the platform A 10-1 to the platform H 10-8 include processors 11-1 to 11-8, respectively. The processors 11-1 to 11-8 may have different architectures. Furthermore, the processors 11-1 to 11-8 may be provided by different manufacturers or may also be provided by the same manufacturer. In the following description, when it is not necessary to distinguish the processors 11-1 to 11-8 from one another and an optional processor is intended, it is described as a processor 11.

The processor 11 controls the platform 10. The processor 11 may be a multiprocessor. Furthermore, the processor 11 may be, for example, any one of a central processing unit (CPU), a micro processing unit (MPU), a graphics processing unit (GPU), a digital signal processor (DSP), an application specific integrated circuit (ASIC), a programmable logic device (PLD), and a field programmable gate array (FPGA). Furthermore, the processor 11 may be a combination of two or more types of elements of the CPU, the MPU, the GPU, the DSP, the ASIC, the PLD, and the FPGA.

The platform 10 has a function of a root complex (RC) that can operate as a host side. The PCIe bridge controller 30 is an example of a relay device. The PCIe bridge controller 30 is provided with the end points (EPs) to relay communication over the bus system among the platforms 10 each having the root complexes connected to the end points. Furthermore, the PCIe bridge controller 30 has a function of the end points including address translation units (ATUs), slots and the like connected to the platforms 10. The root complex and the end point may be, for example, a PCIe root complex and a PCIe end point. In this way, data transfer is performed between the platforms 10 and the PCIe bridge controller 30.

More specifically, the PCIe bridge controller 30 is provided with the plurality of end points. The platform 10 has the root complex connected to the end point of the PCIe bridge controller 30. That is, the root complex of each platform 10 is connected to the corresponding end point of the PCIe bridge controller 30. The PCIe bridge controller 30 controls an internal bus thereof to perform data transfer between the end points. In this way, the PCIe bridge controller 30 implements data transfer by relaying communication among the platform A 10-1 to the platform H 10-8.

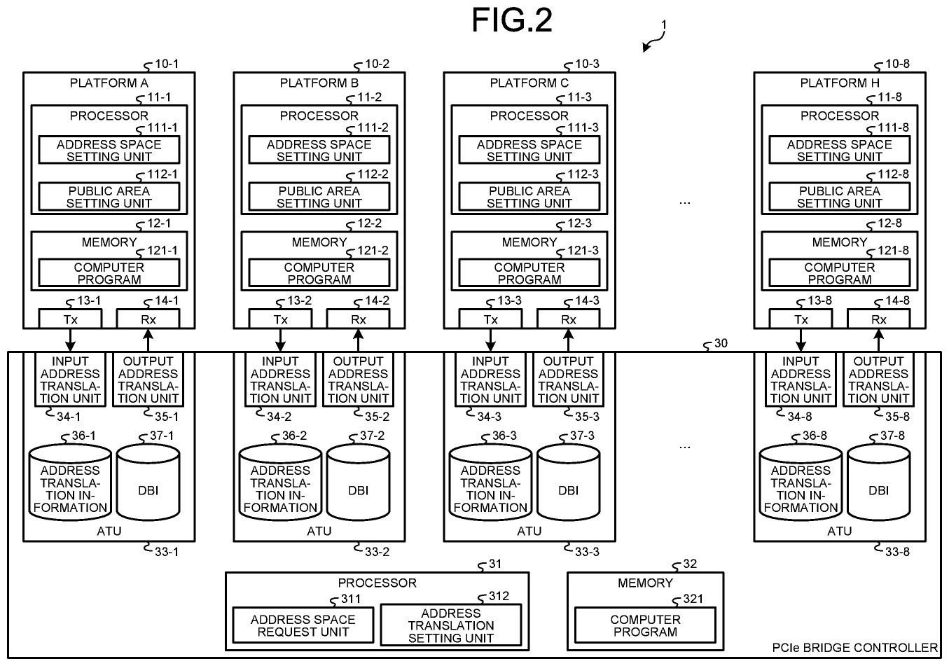

Next, address translation in communication via the PCIe bridge controller 30 will be described. FIG. 2 is a diagram for explaining a hardware configuration of the distributed computer 1 according to the first embodiment.

The PCIe bridge controller 30 includes a processor 31, a memory 32, and ATUs 33-1 to 33-8 corresponding to slots to which the platforms 10 are connected.

The processor 31 is a hardware processor that controls the PCIe bridge controller 30. The processor 31 may be a multiprocessor. Furthermore, the processor 31 may be, for example, any one of the CPU, the MPU, the GPU, the DSP, the ASIC, the PLD, and the FPGA. Furthermore, the processor 31 may be a combination of two or more types of elements of the CPU, the MPU, the GPU, the DSP, the ASIC, the PLD, and the FPGA.

The memory 32 is a storage device including a read only memory (ROM) and a random access (RAM). Various computer programs and data for the computer programs are written in the ROM. A computer program 321 stored in the memory 32 is read and executed by the processor 31. Furthermore, the RAM is used as a working memory.

Furthermore, the processor 31 implements functions illustrated in FIG. 2 by executing the computer program 321 stored in the memory 32. Specifically, the processor 31 is provided with, as functional configurations, an address space request unit 311 and an address translation setting unit 312.

The address space request unit 311 is an example of a request unit. The address space request unit 311 requests a platform 10 to set an address space used to access a data bus interface (DBI) 37 of this platform 10 among address spaces, each being provided in the PCIe bridge controller 30 for each platform 10. The DBIs 37-1 to 37-8 are setting areas in which access information for accessing public areas on memory spaces of the platforms 10. For example, the address space request unit 311 requests the platform A 10-1 to set an address space as a base address register (BAR) 2 used to access the DBI 37-1 of the ATU 33-1, in which access information on this platform A 10-1 is stored.

The public area is an area publicized by each platform 10, and is an area to or from which the other platforms 10 can perform writing or reading. For example, a memory such as a buffer area is designated as the public area. Furthermore, the public area is designated by the platform 10. The access information is information for allowing the platform 10 to access the designated public area. The access information may be, for example, an address of the public area, a translation rule for translating an input address into the address of the public area, or other information. The DBIs 37-1 to 37-8 are areas in which setting of the platforms 10 is stored. In the following description, when it is not necessary to distinguish the DBIs 37-1 to 37-8 from one another and an optional DBI is intended, it is described as a DBI 137. More specifically, the address space request unit 311 requests a platform 10 to set an address space used to access the DBI 37 of this platform 10 from the BAR2. The BAR2 is a register in which a base address used to access the DBI 37 for the corresponding platform 10 is stored. The address space request unit 311 limits the address space, thereby preventing other DBIs 37 from being designated.

The address translation setting unit 312 is an example of a translation rule setting unit. The address translation setting unit 312 sets, in address translation information 36-1 to 36-8, a translation rule of the address translation. The address translation setting unit 312 sets a translation rule, in which an address of the address space requested by the address space request unit 311 and an address of the DBI 37 have been correlated, in the address translation information 36-1 to 36-8.

The ATUs 33-1 to 33-8 are provided for the respective slots to which the platforms 10 are connected. The ATUs 33-1 to 33-8 translate addresses input from the respective platforms 10 and addresses output to the respective platforms 10. In the following description, when it is not necessary to distinguish the ATUs 33-1 to 33-8 from one another and an optional ATU is intended, it is described as an ATU 33.

The ATU 33 is a register circuit to translate an address based on the address translation rule such as the address translation information 36-1 to 36-8. Furthermore, the ATU 33 may be any one of an ASIC, a PLD, and a FPGA. Furthermore, the ATU 33 may also be a combination of two or more types of elements of the ASIC, the PLD, and the FPGA. The ATU 33 may also be a functional unit implemented when the processor 31 executes the computer program 321 stored in the memory 32.

Note that, when accessing different memory address spaces among the platforms 10, each platform 10 accesses a memory address space via a BAR0 in which a base address of the memory address space has been set. However, since the upper bits of the address space of the BAR0 are assigned to slot numbers, addresses used for reading and writing data are limited. This causes a problem that access to an upper space is not possible due to the limitation of the number of bits of the address. In this regard, the ATU 33 performs address translation for avoiding the limitation, and enables access to any desired memory address of each platform 10. Similarly, the ATU 33 enables access to any desired address of the PCIe bridge controller 30.

Since the ATU 33-1 to the ATU 33-8 have substantially the same configuration, the ATU 33-1 will be described as an example. However, respective address translation rules according to the platform A 10-1 to the platform H 10-8 are set in the address translation information 36-1 to 36-8. Furthermore, address information for accessing the respective public areas according to the platform A 10-1 to the platform H 10-8 are set in the DBIs 37-1 to 37-8.

The ATU 33-1 includes an input address translation unit 34-1, an output address translation unit 35-1, the address translation information 36-1, and the DBI 37-1. The input address translation unit 34-1 and the output address translation unit 35-1 may be implemented by a CPU, a MPU, a GPU, a DSP, an ASIC, a PLD, a FPGA and the like.

In the address translation information 36-1, a translation rule for translating an address output from the platform A 10-1 into an address in the address space of the PCIe bridge controller 30. Moreover, it is assumed that the address translation information 36-1 is an example of a translation rule stored in an area, which is other than the DBI 37-1, as an area that is not accessible by the platform 10. That is, the address translation information 36-1 is stored in an area in which the platform 10 is prohibited from performing rewriting.

The DBI 37-1 is a setting area in which information including access information for allowing access to a public area of each of the platform A 10-1 to the platform H 10-8 is set.

The input address translation unit 34-1 is an example of a translation unit. The input address translation unit 34-1 translates an address input from the platform A 10-1, based on the address translation information 36-1 in which the address of the address space requested by the address space request unit 311 and the address of the DBI 37-1 have been correlated. The address translation information 36-1 is stored in an area in which the platform 10 is prohibited from performing rewriting.

More specifically, the address space request unit 311 requests the platform A 10-1 to set an address space of an address for accessing the DBI 37-1. In response, the platform A 10-1 defines, in the BAR2, an address of the requested address space as an address for accessing the DBI 37-1. However, the address defined by the platform A 10-1 is an address of the address space of the platform A 10-1 itself. Thus, when the address of the DBI 37-1 in the address space of the platform A 10-1 is input, the input address translation unit 34-1 translates the input address into an address of the DBI 37-1 in the address space of the PCIe bridge controller 30. At this time the input address translation unit 34-1 translates an address input from the platform A 10-1, based on the address translation information 36-1 in which the address translation rule relative to the platform A 10-1 has been set.

Based on the DBI 37-1 for the platform A 10-1, the output address translation unit 35-1 translates an address to be output from the PCIe bridge controller 30 into an address corresponding to the address space of another platform 10.

Next, the platform 10 will be described. Since the platform A 10-1 to the platform H 10-8 have substantially the same configuration, the platform A 10-1 will be described as an example.

The platform A 10-1 includes a processor 11-1, a memory 12-1, a Tx 13-1, and an Rx 14-1.

The memory 12-1 is a storage memory including a ROM and a RAM. Various computer programs and data and the like for the computer programs are written in the ROM. A computer program 121-1 stored in the memory 12-1 is read and executed by the processor 11-1. Furthermore, the RAM is used as a working memory.

The Tx 13-1 is a circuit to transmit an address and data. The Rx 14-1 is a circuit to receive an address and data.

The processor 11-1 implements the functions illustrated in FIG. 2 by executing the computer program 121-1 stored in the memory 12-1. Specifically, the processor 11-1 includes, as functional configurations, an address space setting unit 111-1 and a public area setting unit 112-1.

The address space setting unit 111-1 sets an address space of the BAR2. More specifically, when connection to the PCIe bridge controller 30 is detected, the address space setting unit 111-1 transmits information representing a maximum address space that can be set as the BAR2, to the PCIe bridge controller 30. In response, the PCIe bridge controller 30 designates an address space that is accessible to the DBI 37-1. Then, the address space setting unit 111-1 sets the designated address space as the address space of the BAR2.

The public area setting unit 112-1 is an example of a setting unit. The public area setting unit 112-1 sets, in the DBI 37-1, access information for allowing access to a public area publicized by the platform A 10-1. More specifically, the public area setting unit 112-1 transmits, to the PCIe bridge controller 30, a setting request for setting the access information used to access the public area. The PCIe bridge controller 30 sets the requested access information in the DBI 37-1. In this way, the public area setting unit 112-1 sets, in the DBI 37-1, the access information for allowing access to the public area.

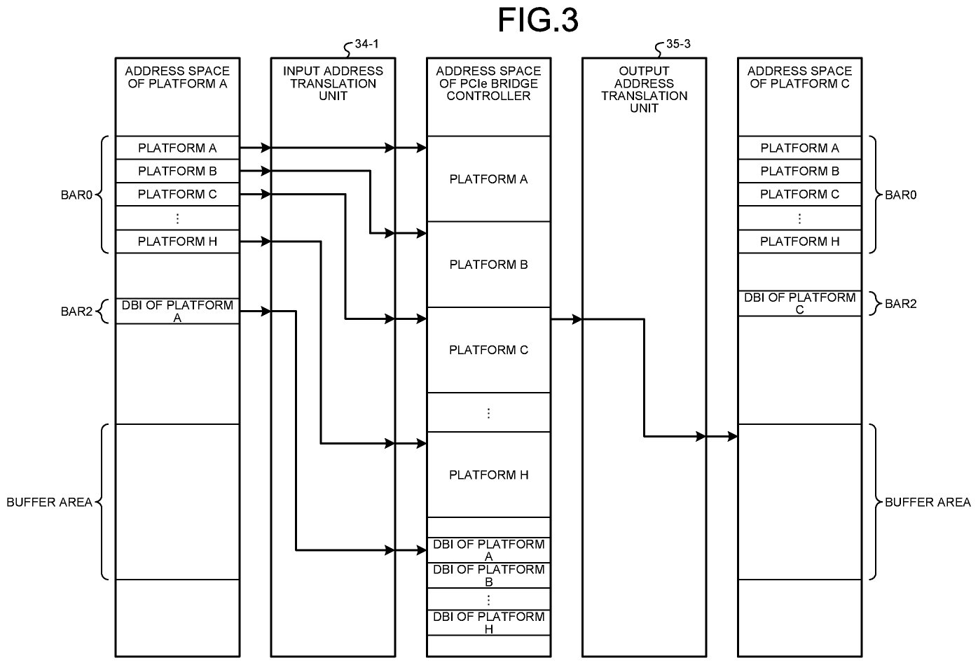

Next, address translation in communication via the PCIe bridge controller 30 will be described. FIG. 3 is a diagram for explaining an example of address translation performed in communication from the platform A 10-1 to the platform C 10-3.

First, with reference to FIG. 3, writing to the DBI 37-1 will be described.

When performing writing to the DBI 37-1, the platform A 10-1 designates the address space of the BAR2. The address space of the BAR2 of the platform A 10-1 is an address space to which the DBI 37-1 can be designated. That is, the platform A 10-1 is allowed to designate only the DBI 37-1, and is not able to designate the DBIs 37-2 to 37-8 of the other platforms 10.

The platform A 10-1 transmits a write request, in which the address of the DBI 37-1 of the platform A 10-1 is designated, from the Tx 13-1 to the PCIe bridge controller 30 by designating the BAR2.

When the write request is received by the PCIe bridge controller 30, the input address translation unit 34-1 translates the address designated by the write request into an address of the address space of the PCIe bridge controller 30 based on the address translation information 36-1. The input address translation unit 34-1 translates the address designated by the write request into the address of the DBI 37-1. Specifically, as indicated by an arrow in FIG. 3, an address of the address space of the platform A 10-1 is translated into an address of the address space of the PCIe bridge controller 30 through the input address translation unit 34-1.

Then, the address space request unit 311 writes in the DBI 37-1 write data requested by the write request, based on the address translated by the input address translation unit 34-1.

Next, with reference to FIG. 3, writing processing to a public area on a memory space, such as a buffer area of the platform 10, will be described.

When performing writing to a public area on the memory space of any one of the other platform B 10-2 to platform H 10-8, the platform A 10-1 designates an address of a target platform (any one of 10-2 to 10-8) in the BAR0 and transmits a write request from the Tx 13-1.

When the write request is received by the PCIe bridge controller 30, the input address translation unit 34-1 translates the address designated by the write request into an address of the address space of the PCIe bridge controller 30 based on the address translation information 36-1.

The processor 31 of the PCIe bridge controller 30 leads the write request based on the address translated by the input address translation unit 34-1. For example, in a case where the write request is directed to the platform C 10-3, the processor 31 leads the write request to the ATU 33-3 that corresponds to the platform C 10-3.

Upon receiving the write request, the output address translation unit 35-3 of the ATU 33-3 translates, based on the DBI 37-3, the address designated by the write request into an address corresponding to a public area on a memory space such as the buffer area of the platform C 10-3. That is, as indicated by arrows in FIG. 3, the output address translation unit 35-3 translates the address of the address space of the PCIe bridge controller 30 into the address of the address space of the platform C 10-3. In this way, the distributed computer 1 carries out writing processing between the platforms 10.

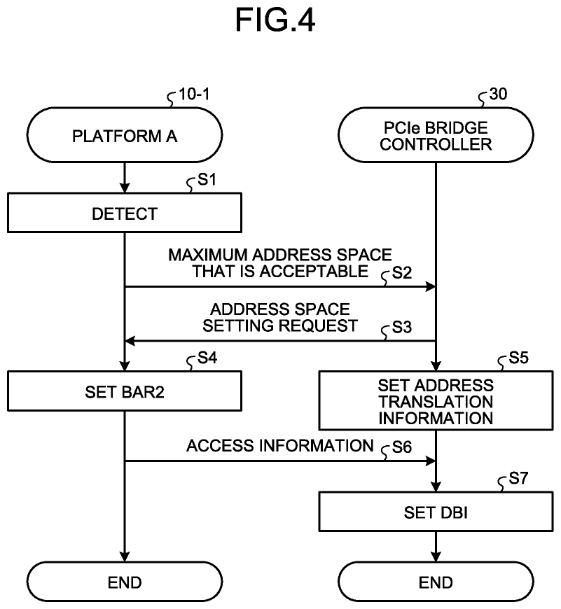

Next, setting processing by the distributed computer 1 will be described. FIG. 4 is a sequence diagram illustrating an example of the setting processing according to the first embodiment. In FIG. 4, the case of the platform A 10-1 will be described as an example. The processing equivalent to that in the platform A 10-1 is performed in each of the platform B 10-2 to the platform H 10-8.

The address space setting unit 111-1 of the platform A 10-1 detects that the PCIe bridge controller 30 is connected (step S1).

The address space setting unit 111-1 transmits information representing a maximum address space that is acceptable as the BAR2, to the PCIe bridge controller 30 (step S2).

The address space request unit 311 of the PCIe bridge controller 30 requests the platform A 10-1 to set, as the BAR2, an address space to which the DBI 37-1 for the platform A 10-1 can be designated (step S3).

The address space setting unit 111-1 of the platform A 10-1 sets the designated address space as the BAR2 (step S4).

The address translation setting unit 312 of the PCIe bridge controller 30 sets, in the address translation information 36-1, a translation rule of the address translation for the platform A 10-1 (step S5).

The public area setting unit 112-1 of the platform A 10-1 requests the PCIe bridge controller 30 to set, in the DBI 37-1, access information for allowing access to the public area on the memory space such as the buffer area of the platform A 10-1 (step S6).

The address translation setting unit 312 of the PCIe bridge controller 30 sets the designated access information in the DBI 37-1 (step S7). After that, the output address translation unit 35-1 can transmit an address of the public area such as the buffer area to another platform 10 by translating an address based on the DBI 37-1.

As described above, according to the distributed computer 1 of the first embodiment, the address space request unit 311 of the PCIe bridge controller 30 requests, as the address space of the BAR2, a platform 10 to set an address space for accessing the DBI 37 of this platform 10. That is, the address space request unit 311 requests the platform 10 to set an address space that allows this platform 10 to access the DBI 37 thereof. Here, the input address translation units 34-1 to 34-8 translate addresses based on the address translation information 36-1 to 36-8, respectively. Therefore, even though the address space of the BAR2 is limited, since the platforms 10 rewrite the address translation information 36-1 to 36-8, the address of the address space of the BAR2 can be correlated with the addresses of the DBIs 37 of the other platforms 10. Considering this problem, the address translation information 36-1 to 36-8 is stored in areas in which the platforms 10 are prohibited from rewriting or even accessing. In this way, the PCIe bridge controller 30 does not allow a platform 10 to access the DBIs 37 of the other platforms 10. Therefore, the PCIe bridge controller 30 can prevent a non-public area from being made public.

### Second Embodiment

In the foregoing first embodiment, the address translation information 36-1 to 36-8 is independent from the DBIs 37-1 to 37-8 and is stored in areas in which the platforms 10 are prohibited from rewriting or accessing. Accordingly, a change in the address translation information 36-1 to 36-8 by the platform 10 is prevented as described above. In the second embodiment, a change in the address translation information 36-1 to 36-8 is prevented by a method different from the method of the first embodiment. Note that redundant components will be described with the same reference numerals.

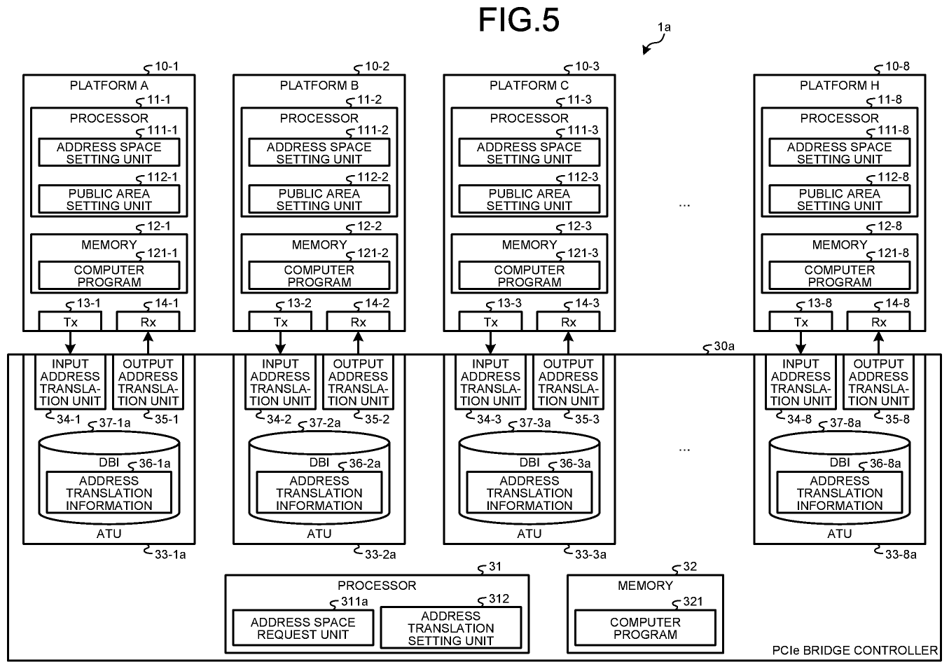

FIG. 5 is a diagram for explaining a hardware configuration of a distributed computer 1a according to a second embodiment. In ATUs 33-1a to 33-8a according to the second embodiment, address translation information 36-1a to 36-8a is stored within DBIs 37-1a to 37-8a. The DBIs 37-1a to 37-8a are examples of setting areas in which the address translation information 36-1a to 36-8a, each being an example of the translation rule, has been set.

The address space request unit 311 according to the foregoing first embodiment requests a platform 10 to set an address space to which the DBI 37 for this platform 10 can be designated. On the other hand, an address space request unit 311a according to the second embodiment requests a platform 10 (for instance, 10-1) to set an address space to which part of the DBI 37 (37-1a) for this platform 10 (10-1) can be designated. The part of the DBI 37 (37-1a) is an area other than part of this DBI 37 (37-1a) in which the address translation information 36 (36-1a) has been stored. That is, the address space request unit 311a requests a platform 10 to set an address space to which a remaining area, excluding a storage area of the address translation information 36, can be designated.

Thus, in a case of the platform A 10-1, the address space setting unit 111-1 sets, as an address space of the BAR2, the address space to which the DBI 37-1a, other than a storage area of the address translation information 36-1a, can be designated. In this way, the address space request unit 311a can conceal, from the platform A 10-1, not only the DBIs 37-2a to 37-8a of the other platforms 10 but also the address translation information 36-1a of the platform A 10-1 itself.

As described above, the address space request unit 311a according to the second embodiment is capable of concealing, from the platform A 10-1, not only the DBIs 37-2a to 37-8a of the other platforms 10 but also the address translation information 36-1a. Therefore, the PCIe bridge controller 30 can prevent a non-public area from being made public.

In the foregoing embodiments, while the PCIe has been described as an example of a bus system (for example, an expansion bus system) or an I/O interface of each part, the bus system or the I/O interface is not limited to the PCIe. For example, it is sufficient that the bus system or the I/O interface of each part corresponds to a technology capable of performing data transfer between a device (peripheral controller) and a processor over a data transfer bus. The data transfer bus may be a general-purpose bus capable of transferring data at a high speed in a local environment (for example, one system or one device) provided in a single housing and the like. The I/O interface may be any one of a parallel interface and a serial interface.

The I/O interface may be configured to perform a point-to-point connection and serially transfer data on a packet basis. In the case of serial transfer, the I/O interface may have a plurality of lanes. The layer structure of the I/O interface may have a transaction layer that generates and decodes a packet, a data link that performs error detection and the like, and a physical layer that performs serial-parallel conversion. Furthermore, the I/O interface may include a root complex, which has one or a plurality of ports at the top of the hierarchy, an end point being an I/O device, a switch for increasing ports, a bridge that converts a protocol, and the like. The I/O interface may transmit data to be transmitted and a clock signal by multiplexing them with a multiplexer. In such a case, a reception side may separate the data and the clock signal by a demultiplexer.

Each of the computer programs 121 and 321 provided in the platforms 10 and the PCIe bridge controller 30, respectively, may be stored in a computer-readable storage medium, such as a CD-ROM, a CD-R, a memory card, a digital versatile disc (DVD), and a flexible disk (FD), as a file in an installable format or an executable format, and provided as a computer program product. Alternatively, each of the computer programs 121 and 321 may be stored on a computer connected to a network such as the Internet, and provided by being downloaded over the network. Alternatively, each of the computer programs 121 and 321 may be provided or distributed over network such as the Internet.

Although the disclosure has been described with respect to only a limited number of embodiments, those skilled in the art, having benefit of this disclosure, will appreciate that various other embodiments may be devised without departing from the scope of the present invention. Accordingly, the scope of the invention should be limited only by the attached claims.

What is claimed is:

1. A relay device comprising:
a plurality of end points that relay communication over a bus system among a plurality of information processing devices comprising root complexes connected to the end points;
a hardware processor that requests one of the information processing devices to set an address space used to access a setting area for the one of the information processing devices among setting areas each being provided in the relay device for each information processing device, the setting areas being areas in which access information for accessing public areas on memory spaces of the information processing devices are set; and
circuitry that translates an address input from the one of the information processing devices, based on a translation rule in which an address of the address space requested by the hardware processor has been correlated with an address of the setting area for the one of the information processing devices, the translation rule being stored in an area in which the information processing devices are prohibited from performing rewriting.

2. The relay device according to claim 1, wherein the area in which the translation rule is stored is an area in which the information processing devices are prohibited from accessing.

3. The relay device according to claim 1, wherein
the translation rule is stored within the setting area, and
the hardware processor requests the one of the information processing devices to set an address space used to access part of the setting area for the one of the information processing devices, the part of the setting area being an area other than part of the setting area in which the translation rule has been stored.

4. A computer program product comprising a non-transitory computer-readable recording medium in which an executable program is recorded, the program being executed by a computer as a relay device that comprises a plurality of end points to relay communication over a bus system among a plurality of information processing devices comprising root complexes connected to the end points, the program instructing the computer to:
request one of the information processing devices to set an address space used to access a setting area for the one of the information processing devices among setting areas, wherein each being provided in the relay device for each information processing device, the setting areas being areas in which access information for accessing public areas on memory spaces of the information processing devices are set; and
set a translation rule in which an address of the requested address space has been correlated with an address of the setting area for the one of the information processing devices.

5. An information processing system comprising:
a plurality of information processing devices each of which comprises a root complex; and
a relay device that comprises a plurality of end points to relay communication over a bus system among the information processing devices each connected to the end point via the root complex, wherein
each of the information processing devices sets access information for accessing a public area on a memory space of the corresponding information processing device, and
the relay device further comprises:
a hardware processor that requests one of the information processing devices to set an address space used to access a setting area for the one of the information processing devices among setting areas each being provided in the relay device for each information processing device, the setting areas being areas in which access information for accessing public areas on memory spaces of the information processing devices are set; and
circuitry that translates an address input from the one of the information processing devices, based on a translation rule in which an address of the address space requested by the hardware processor has been correlated with an address of the setting area for the one of the information processing devices, the translation rule being stored in an area in which the information processing devices are prohibited from performing rewriting.
